(19) United States
(12) Patent Application Publication
(10) Pub. No.: US 2015/0034537 A1
(43) Pub. Date: Feb. 5, 2015

(54) Automatic Drinking Water Enhancement Apparatus

(71) Applicant: David Warren Parish, SR., Kimberly, ID (US)

(72) Inventor: David Warren Parish, SR., Kimberly, ID (US)

(21) Appl. No.: 13/953,741

(22) Filed: Jul. 30, 2013

(51) Int. Cl. C02F 1/68

(52) U.S. Cl. CPC C02F 1/686
USPC 210/101

(57) ABSTRACT

This invention is for an automatic drinking water enhancement apparatus consisting of a storage reservoir for water enhancement liquid connected to a positive displacement pump that will pump said water enhancement liquid proportional to the drinking water supply flow rate, and a merging and mixing means to combine the two streams, and an output leading to the dispenser to the user. The positive displacement pump may be powered by the drinking water stream flow and pressure, or by an electric motor with suitable electronic or computerized controls and sensors to drive the motor and infusion pump speed proportional to the filtered water flow rate, or as otherwise controlled. Fixed and variable control of the water enhancement liquid concentration in the output drinking water stream are included. Because it operates automatically, in the simplest embodiment the use requirements for this apparatus are the same as using a filtered water delivery faucet, plus keeping the water enhancement reservoir filled on occasion as necessary. If a user controlled water enhancement concentration approach embodiment is used, the user will have the additional use requirement to adjust the control input device to specify the desired water enhancement liquid concentration.

### BACKGROUND OF THE INVENTION

1. Field of the Invention

The field of this invention relates to drinking water treatment, and more specifically to an apparatus that automatically adds water enhancement liquid to a filtered drinking water stream, thereby making drinking water that is both filtered and enhanced with additives.

2. Discussion of the Prior Art

Unwanted and potentially harmful contamination in water, especially drinking water, is of concern to many people. This concern creates a desire for water filtration devices in the home and elsewhere.

People have greatly increased their consumption of filtered or processed water in recent years. Many people choose filtered water because they like the taste or because they believe it is a healthier option than tap or well water.

Many water filtration devices and methods have been developed to remove or neutralize particulate, chemical, or other undesirable contaminants. Major categories of consumer water filtration systems include plumbed-in or faucet-mount systems that rely on the pressure of the water supply to force untreated water through a water treatment device; and non-plumbed, pour though or batch systems that rely on gravity to move water from an upper influent water chamber, through a filtering means to a lower effluent water chamber.

Some of these existing water filter systems, like reverse osmosis or nano-membrane filters are highly effective at removing virtually all contaminants, but they also remove desirable minerals like calcium, magnesium, and similar contents, and this is often perceived as a disadvantage.

In addition, there is an increasing demand for dietary supplements, such as vitamins, minerals, and herbs, as part of maintaining overall health. It is desirable, as an outgrowth of water filtration, to offer enhancements to add to filtered water to support the health of consumers. Although enhancements can be purchased separately and added to filtered water, it is inconvenient to have to open a package or several packages to get the mix of enhancements desired. It is even more inconvenient to do this repeatedly for each glass of filtered water, requiring additional time and utensils. Furthermore, it is not very useful to mix up a large batch of filtered, enhanced water, as many enhancements change over time after mixing into water. Accordingly, there is a need for improved devices and methods for adding enhancements to filtered water.

Therefore the subject of this invention addresses a need that exists for a drinking water enhancement apparatus that acts subsequent to a drinking water filter, to automatically add a metered amount of a water enhancement liquid to the filtered drinking water stream proportional to water flow, then mix and dispense the resulting enhanced drinking water to the user.

Other inventions in the prior art differ in that they do not deliver a metered concentration of water enhancement liquid proportional to water flow rate so the concentration will vary over time, or they focus on single serving beverage dispensing and integrate cartridges of water enhancement liquid, and/or integrate water filters with a water enhancement infuser thereby comprising a system, and/or they do not offer the option of being powered entirely by water pressure and flow thereby making the installation easier.

The advantage of this invention is that the user can have a convenient way of obtaining drinking water that is essentially filtered to be contaminant free, and supplemented with water enhancement liquids like minerals and vitamins additives, providing clean, safe, good tasting and healthy wholesome water.

### BRIEF SUMMARY OF THE INVENTION

This invention is for an automatic drinking water enhancement apparatus comprising a storage reservoir of water enhancement liquid, or a tube connected to a standard storage reservoir containing said water enhancement liquid, connected to allow enhancement fluid flow to a positive displacement pump that will pump said water enhancement liquid proportional to the filtered drinking water supply flow rate, and a merging and mixing means to combine the filtered drinking water and water enhancement liquid then dispense it to the user. Because it operates automatically, in the simplest embodiment the use requirements for this apparatus are the same as using a filtered water delivery faucet, plus keeping the water enhancement reservoir filled on occasion as necessary. If a user controlled water enhancement concentration approach embodiment is used, the user will have the additional use requirement to adjust the control input device to specify the desired water enhancement liquid concentration.

### BRIEF DESCRIPTION OF THE SEVERAL VIEWS OF THE DRAWINGS

The accompanying drawings, which are included to provide a further understanding of the invention and are incorporated in and constitute a part of this specification, illustrate embodiments of the invention and together with the description, serve to explain the principles of the invention:

FIG. 1 illustrates an isometric overview of the automatic water enhancement apparatus;

FIG. 2 illustrates an isometric detail view of the manifold, water impeller, and main shaft;

FIG. 3 Illustrates an isometric detail view of the water impeller, fixes to the driven gear with shaft, and adjacent idler gear, which constitute one embodiment of a gear type positive displacement pump;

FIG. 4 illustrates a detail view of the gear type positive displacement pump and associated parts;

FIG. 5 illustrates an isometric exploded view of the right side of the automatic water enhancement apparatus;

FIG. 6 illustrates an isometric exploded view of the left side of the automatic water enhancement apparatus;

FIG. 7 illustrates a transparent view, shown from the left side, illustrating the function of the water enhancement apparatus;

FIG. 8 illustrates the attachment means for the concentrate reservoir with the manifold by way of a cylindrical female fitting with o-ring seal, and the concentrate supply port 12.

FIG. 9 illustrates the manifold 1 with an internal port 13 feeding into the cylindrical recess for the water impeller 7.

FIG. 10 illustrates a second alternative embodiment where the reservoir is remotely located, and the concentrate is supplied to an alternate manifold 28 by a rigid or flexible tube 27.

FIG. 11 illustrates a detail of the second alternative embodiment manifold emphasizing the supply port 26 feeding the inlet port 12.

FIG. 12 illustrates a third alternative embodiment that features a remotely located reservoir and positive displacement pump, allowing a one piece manifold 39, where the flow sensing is accomplished without moving parts by means of differential pressure sensing of the water flow across a restrictive orifice as measured at pressure sensor ports 32 and 33.

FIG. 13 illustrates a cross section of manifold 39, detailing the flow restrictor orifice 37 located in the filtered water stream, and the pressure sensing chambers and sensor ports.

FIG. 14 illustrates an isometric view of the manifold 39 illustrating its relative simplicity.

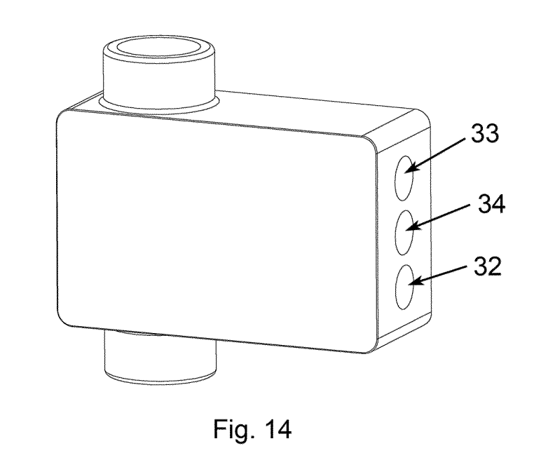

FIG. 15 illustrates a block diagram for an electronic or microcomputer based flow sensor and positive displacement pump control system, allowing more complex features like multi rate, linear or nonlinear concentrate addition, and user input controls.

FIG. 16 illustrates a detail of the one way flow flapper valve 17.

FIG. 17 shows a typical under-counter installation schematic following a typical in-home water filter configuration 42

FIG. 18 shows a block diagram of one embodiment of this invention

FIG. 19 shows a block diagram of an alternative embodiment of this invention

FIG. 20 shows a block diagram of another alternative embodiment of this invention

### DETAILED DESCRIPTION OF THE INVENTION

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical, background, brief summary or the following detailed description or drawings.

The following detailed description describes parts that may be manufactured by various conventional means, but it is intended in most cases they will be made using injection molded plastic, and possibly injection molded urethane for some low durometer (soft and flexible) parts as identified. However, alternative manufacturing using conventional machining methods (like metal machining mill, lathe, grinder, drills, etc.) and materials (stainless steel, aluminum, brass, etc.) are equally possible, and also fully encompassed within the scope of this invention.

This invention is for an apparatus that automatically adds a metered amount of a concentrated liquid water enhancement liquid to a pressurized stream of filtered drinking water in a continuous process so long as the stream of drinking water is flowing. The result of this is the automatic production at the faucet at the time of use of filtered drinking water with water enhancement liquids added to improve the waters mineral, vitamin, sweetener, odor, color or other properties as desired by the user and as governed by the specific formulation of the water enhancement liquid being added. This apparatus offers an end user the ability to improve filtered drinking water, like reverse osmosis drinking water, with subsequent supplement additions to increase the drinking waters mineral and vitamin contents, or other desired properties as noted, so that the drinking water they consume is more healthy and/or good tasting.

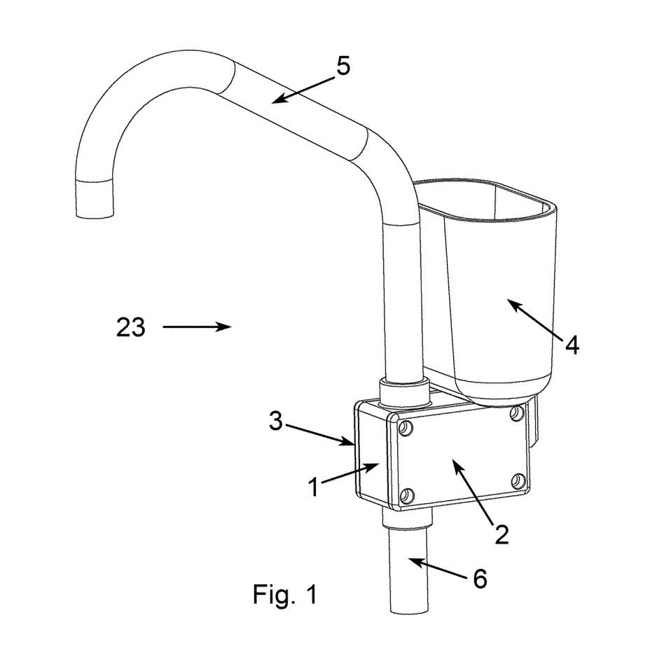

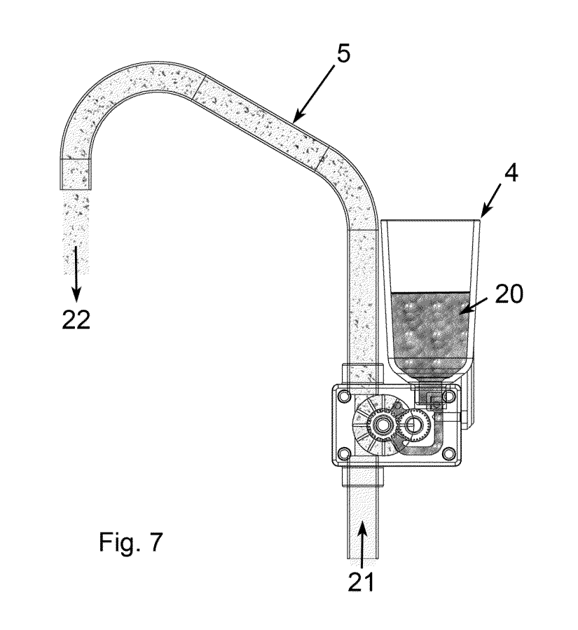

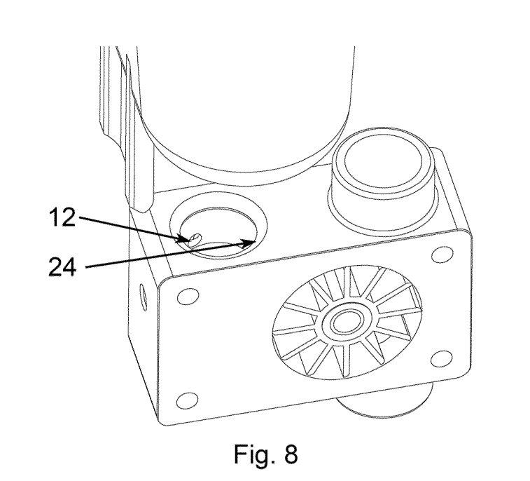

Detailed reference will now be made to the exemplary first preferred embodiment of the present invention, examples of which are illustrated in FIG. 1-9 and FIG. 16. An automatic water enhancement apparatus 23 as shown in FIG. 1 consists of a reservoir 4, which may optionally have a lid to cover said reservoir if desired, to hold a concentrated water enhancement liquid 20 (FIG. 7). Said reservoir 4 attaches to a manifold 1 with a slide fit between a hollow tube feature on the bottom of 4 that slides into a hole with o-ring seal 24 on manifold 1 (FIG. 8) such that fluid flows into port 12.

Manifold 1 has two water tight side covers 2 and 3 that function to seal the manifold on the outer side surfaces, and may be attached by suitable screw fasteners or similar conventional fasteners in each side cover in each of the four corner holes 14; said fasteners that are not shown in the figures for simplicity and clarity in the drawings. These side covers may have a gasket or elastomeric o-ring seal around the periphery of these side covers if necessary to enhance this water tight feature.

This automatic water enhancement apparatus may be attached to a drinking water faucet dispenser by way of a lower attachment tube 6, that may be made of metal or plastic and may have faucet specific features like mounting groves, locking clips, threaded attachment nuts, o-rings or other attachment features added as needed to allow attachment to one or more water faucet types.

This automatic water enhancement apparatus may have an upper enhanced water dispenser tube 5 to deliver the drinking water to the user with a suitable geometric shape, one example of which is shown in FIG. 1.

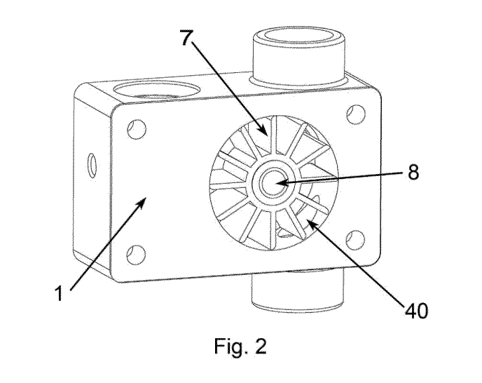

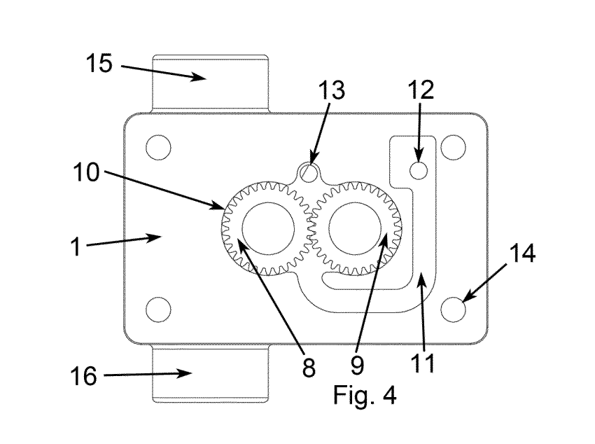

Said lower attachment tube 6 functions to supply pressurized filtered water flow from or in conjunction with a water faucet into the bottom port flange 16 of the manifold 1, as shown as water column flow 21 in FIG. 4 and FIG. 7, and into an internal manifold port 40 to the water wheel 7 as seen in FIG. 2, thus supplying water pressure to a multiplicity of water vanes integral to the water wheel impeller 7, thereby causing it to rotate about the central extended shaft with gear 8 when the water faucet is on and water flows.

The preferred embodiment of said water wheel impeller is anticipated to be made from a low durometer (soft and flexible) sanitary type plastic or urethane that is drinking water safe, and allows a slight contact or an interference fit with the cylindrical walls of the manifold water wheel recess to implement a seal to minimize or eliminate water leakage around the water wheel vanes as it rotates, thereby implementing a volumetric constraint that makes the water wheel rotational speed proportional to the supply water flow rate.

Said water wheel 7 is injection molded with a center hole and may be press fit, thermally bonded, glued, or threaded to the extended shaft with driven spur gear 8. Driven spur gear 8 (and water wheel rotary shaft) may alternatively be implemented using two pieces and possibly made of two different materials if desired for manufacturability or cost reasons.

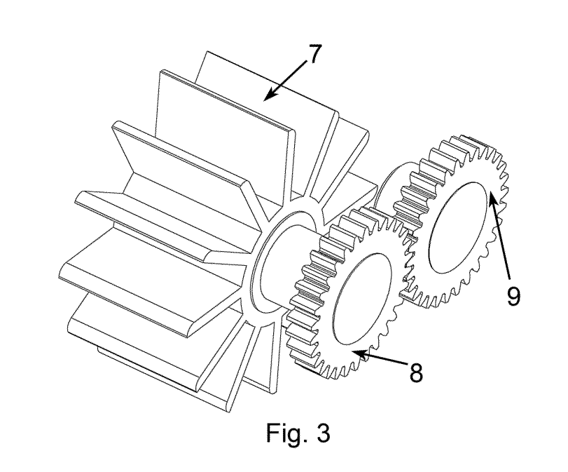

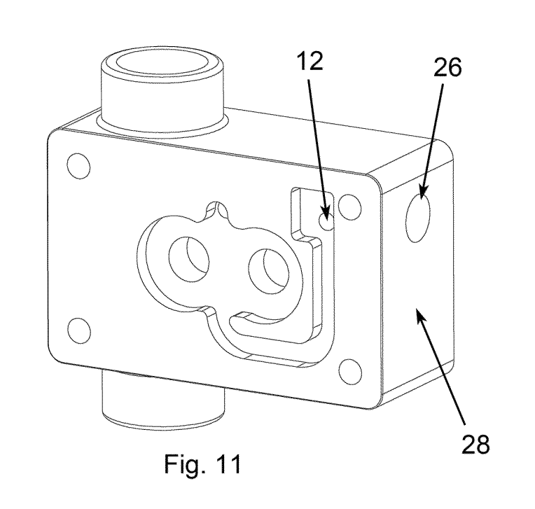

Manifold 1 houses said internal water wheel impeller 7 driving an extended shaft with driven spur gear on one end 8, as shown on FIG. 2 and FIG. 3. This driven extended shaft with spur gear 8 meshes with and drives another idler spur gear 9 as shown in FIG. 3, both of which are enclosed inside a close fitting hydraulic manifold chamber that is recessed into said manifold 1, and featuring a close fitting contoured outer circumferential seal around the two spur gears as illustrated partially as curved outline 10 as shown in FIG. 4, and in isometric view in FIG. 11, such that this pair of spur gears implements one embodiment of a positive displacement pump. The driven spur gear 8 gear teeth subsequently engage with an idler spur gear 9, thereby causing the pair to rotate together synchronously. The size and pitch of the spur gear teeth on the two meshed spur gears defines the void volume between these teeth, and that void volume constraint governs the positive displacement pump liquid volume pump transfer function as a function of the gears angular velocity.

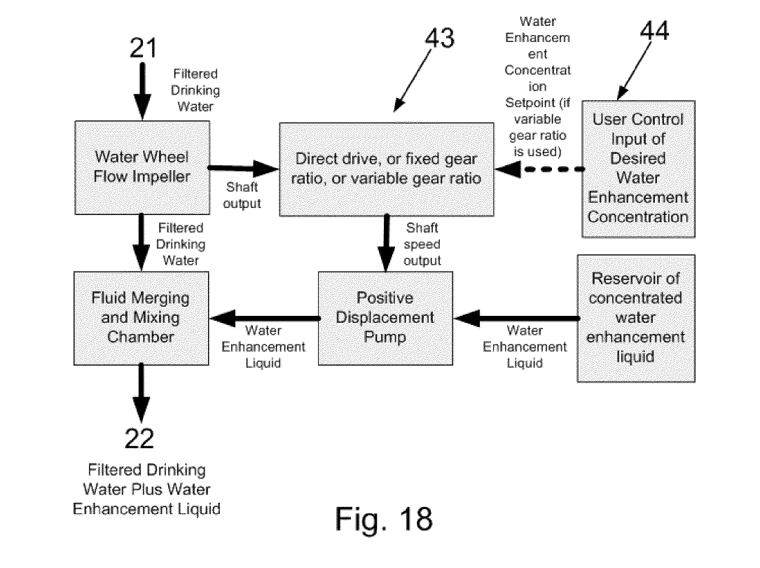

The extended shaft with spur gear 8 and idler gear 9 may be considered to be a drive positive displacement pump. This configuration and alternative embodiments are show in block diagram form in FIG. 18, illustrating that the water wheel impeller shaft may be direct drive, or a constant gear ratio, or a variable gear ratio coupled to the positive displacement pump. A direct drive embodiment is highly compact and cost effective. A constant gear ratio may allow greater control over the water enhancement liquid infusion rate, since it is possible for the constant gear ratio to be changed by exchanging gear sets. A variable gear ratio coupling, which may be discretely changed as by multiple selectable gear sets, or continuously variable (minutely changed) as by opposing conic input and output cylinders coupled by a sliding idler contacting both cones, allows the greatest control and the most user convenience, by allowing the user to control the water enhancement infusion rate by means of a user selection input such as a dial, slide, knob, mechanism, linkage, idler or similar mechanical, electrical, magnetic or other means.

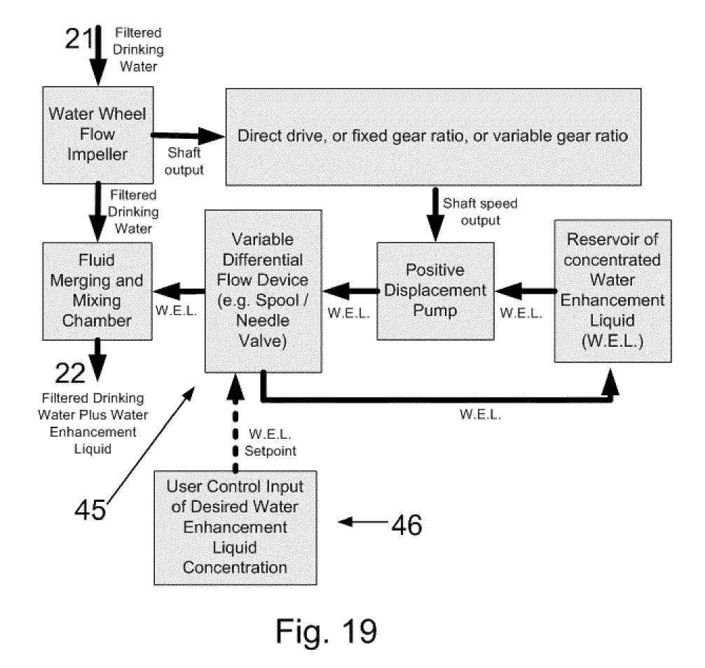

An alternative means to allow user control over the water enhancement liquid concentration in the enhanced drinking water, is to add a user adjustable input device 46 influencing a enhancement fluid flow control device, like block 45 shown in FIG. 19, allowing the positive displacement pumps output flow to be adjusted so that some output flows to the fluid merging and mixing chamber, and some output returns to the reservoir 4. This fluid flow control device 45, also known as a differential flow divider, may be implemented by way of a spool valve, needle valve, pressure restricting orifices, flow control channels and manifolds, or combinations thereof, or by similar means and techniques common in existing fluid control device art.

Said positive displacement pump has an inlet duct channel 11 embedded in the manifold 1 that comes from an inlet port 12 that supplies the liquid from the water enhancement concentrate fluid reservoir 4 through port 12 shown on FIG. 4 and FIG. 8.

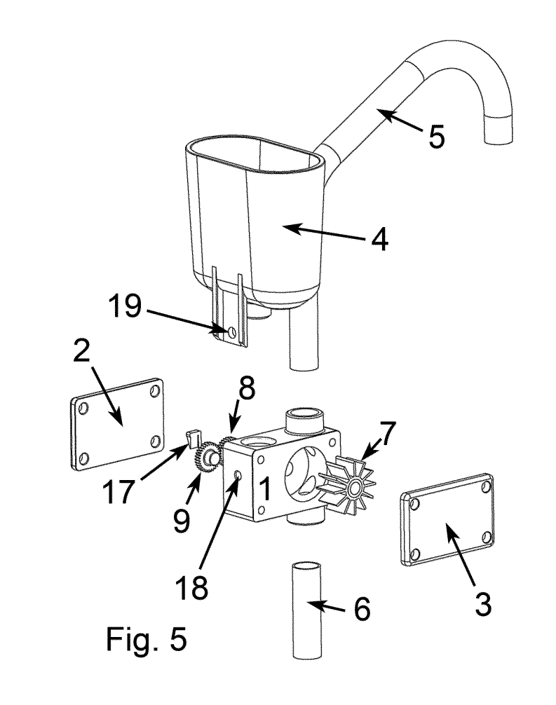

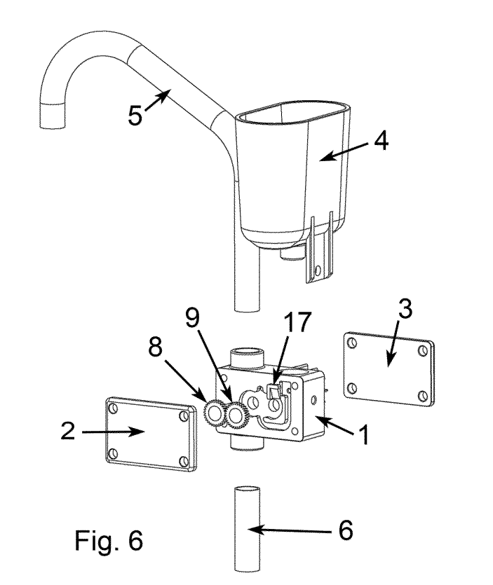

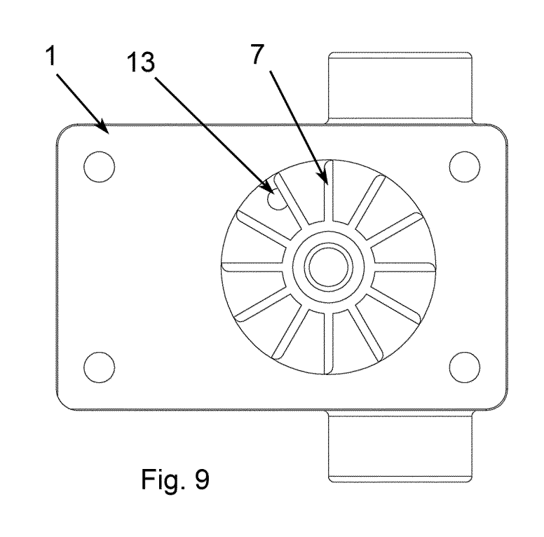

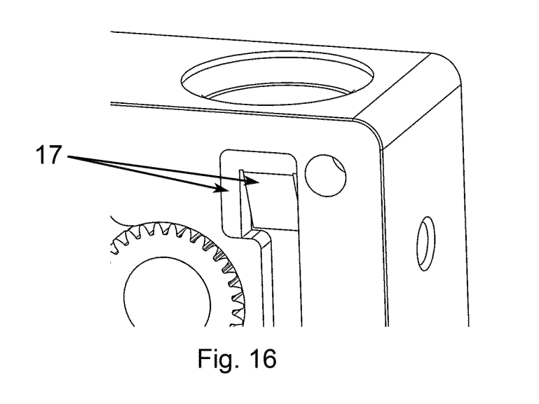

Port 12 and the surrounding area embedded in manifold 1 also house an elastic directional flow flapper valve 17, shown in exploded view FIG. 5 and FIG. 6 and in detail view FIG. 16, implementing a directional flow valve allowing one way flow of liquid through said positive displacement gear pump and directed uniquely from the reservoir 4 toward the outlet port 13 that intersects the impeller wheel cavity in the manifold 1, shown in FIG. 9, thereby injecting then mixing the pumped concentrate with the filtered water flow volume. Infusion of the water enhancement liquid with the filtered water stream can also be introduced at other locations as well. Said elastic directional flow valve 17 may be of multiple embodiments and types including a flapper valve, diaphragm valve, or check-ball type design. The preferred embodiment as shown, for reasons of compactness and cost effectiveness, is a flapper valve that is injection molded from a low durometer (soft and flexible) plastic or urethane, such that it can easily deflect outward away from port 12 allowing a gap for the liquid concentrate to flow toward the gear pump when the gear pump is being driven and pulling concentrate fluid from the reservoir. Alternatively when the filtered water faucet is off and the gear pump is stationary, the water level in the outlet dispenser tube 5 may be higher than the liquid concentrate level 20, and this liquid height difference will cause a pressure difference so the elastic directional flow flapper valve 17 can deflect inward toward the surface around port 12, sealing the port and avoiding water flow backward into the water enhancement concentrate reservoir 4. This flapper may also be a hybrid molded part, with a flapper structure overall, but a ball shape at the sealing surface to intersect the tangential curve of contact with port 12.

By using the water wheel impeller 7 multiple cavities quantity and volume constraint, plus the positive displacement spur gear pump teeth quantity and tooth geometry and cavities volume constraint, a precisely metered amount of the concentrated water enhancement liquid 20 can be determined, by calculation and/or test calibration, per unit volume of filtered water flowing, such that this automatic water enhancement apparatus 23 will automatically infuse the filtered water stream 21 with a metered amount of concentrated water enhancement liquid 20 and subsequently deliver it to the output port flange 15 then outlet dispenser tube 5 and thereby to the user in a mixed stream 22 as illustrated in FIG. 7.

The water enhancement concentrated fluid reservoir 4, may be fixed to the manifold 1 by means of a screw fastener between a clearance hole 19 on the reservoir, and fastener engagement hole 18, or alternatively feature a quick release spring loaded ball detent at location 18, located in the manifold 1 such that it will engage and retain a molded feature 19 located on the retaining tab of the fluid reservoir 4. This is one embodiment of a quick change attachment for one or more water enhancement liquid reservoirs to allow alternative water supplement concentrates to be attached interchangeably at the faucet as one option for this invention. In the case of a quick change feature design, the reservoir 4 may also feature a diaphragm seal on the port opening to allow removal of a fully or partially full reservoir without spilling the concentrated water enhancement liquid contents of the reservoir. Other ramifications of this quick change feature for the water enhancement liquid reservoir are obviously possible.

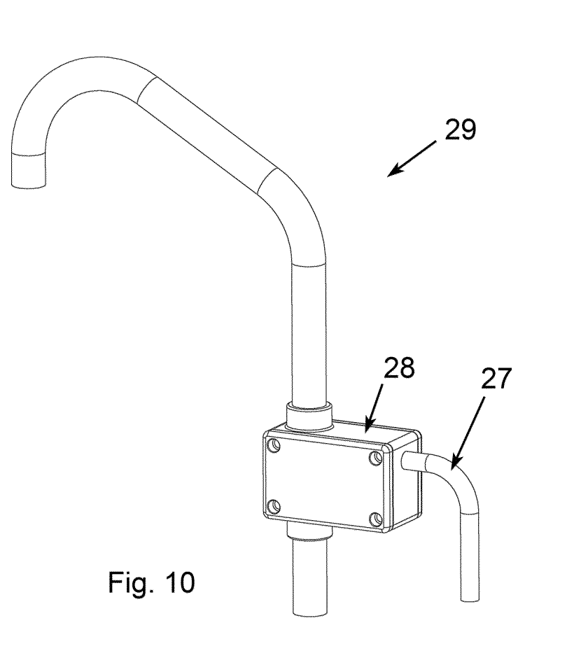

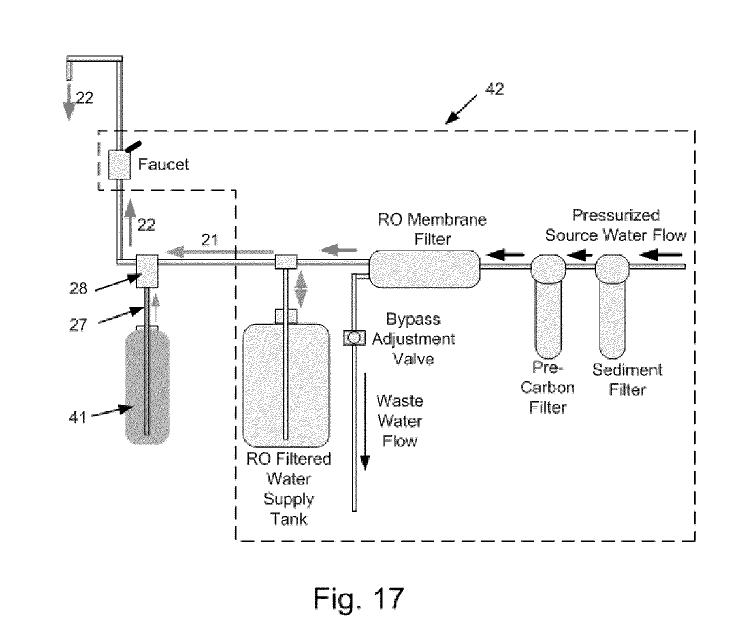

A second exemplary alternative embodiment 29 of the water enhancement liquid delivery apparatus may be implemented by using a modified manifold structure 28 shown in FIG. 10, with the elimination of the concentrate supply hole with o-ring 24 previously used on manifold 1, and the addition of a hole or barbed fitting 26 that intersects with the inlet port 12, thereby allowing a flexible or rigid tube 27 shown in FIG. 10, to deliver the concentrated fluid 20 from an alternative remote location to the inlet port 12, with the rest of the apparatus operating identically. Due to the use of a positive displacement pump, that is driven by a water wheel impeller by a virtually incompressible fluid (water), and due to the delivery of a virtually incompressible water enhancement concentrate fluid, a significant advantage of this approach is that it allows the supply tube 27 to be relatively long, such as one to two meters long, to reach a large water enhancement liquid reservoir like a one gallon bottle of water enhancement liquid, located for instance in the cabinet beneath the counter top and drinking water faucet and dispenser as would be common for many household or office installations. The large reservoir volume of this concentrated drinking water enhancement liquid supply would make enhanced drinking water available for extended times without refilling, thereby aiding convenience. Further this configuration would easily be adapted to be fully integrated with the faucet structure, eliminating unsightly external hoses, and making a cleaner and more self contained installation and appearance. In a similar way, this inventions entire apparatus could be easily adapted to be installed in-line with existing filtered water supply lines, so it could be fully installed below the countertop so no visible reservoirs, manifolds, or other apparatus would be visible, and the user could use or retain their existing water filter system and faucet virtually in its entirety. FIG. 17 illustrates a schematic of this type approach. As such, this drinking water enhancement apparatus invention may be an upgrade to an existing drinking water filter systems, or a part of a new installation.

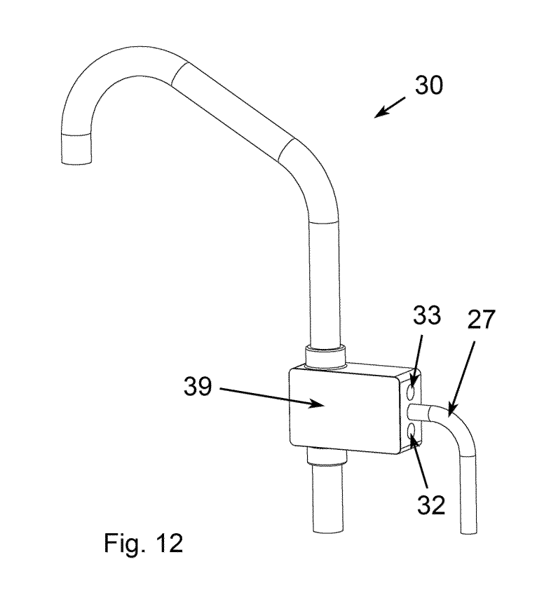

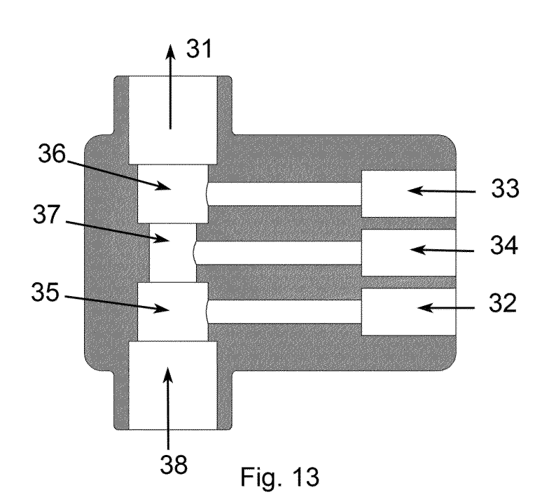

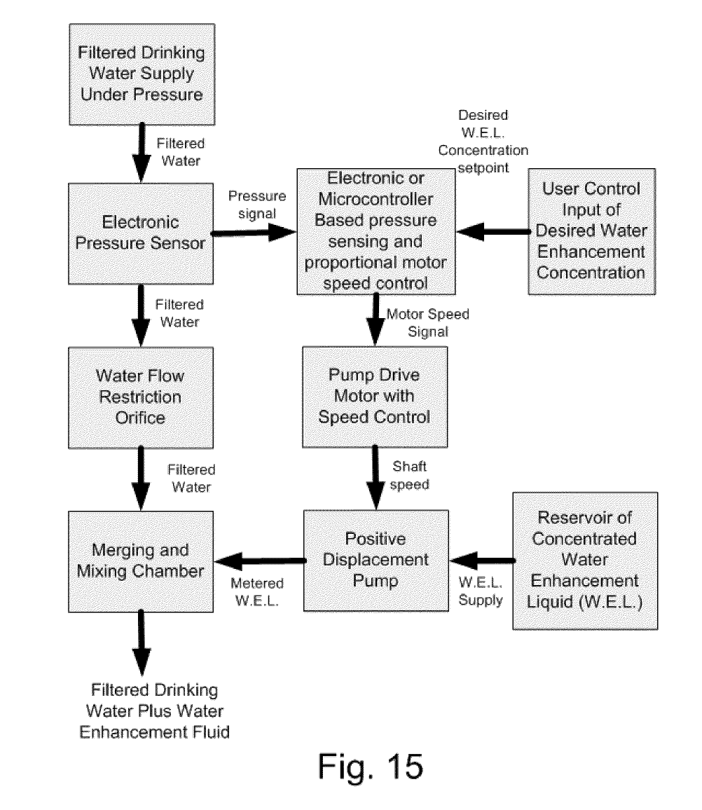

A third exemplary alternative embodiment 30 of the automatic water enhancement liquid delivery apparatus may be implemented using electronic flow sensing and electronic positive displacement pump control of the drinking water enhancement liquid as further described herein. By using a modified manifold structure 39 shown in FIG. 12, featuring an alternative water flow measurement technique utilizing differential pressure sensors located on up-stream 32 and down-stream 33 of a restrictor orifice 37 shown in a centerline section FIG. 13, water flow can be measured, since when the drinking water faucet valve is opened water flows into the inlet 38 and toward the outlet 31 causing a higher pressure in chamber 35 and measured in an adjoining pressure sensor location 32, and a lower relative pressure is produced in chamber 36 and measured in an adjoining pressure sensor location 33. Conventional fluid pressure sensors that may be located in locations 32 and/or 33 are commercially available that will produce an electronic signal, either analog or digital, that is proportional to the pressure at these locations, either absolute pressure or pressure with respect to atmospheric, allowing an electronic connection to a simple electronic circuit implementing proportional motor speed controller, or alternatively a software programmable microcontroller type embedded control computer to measure the pressure by way of the electronic pressure sensor(s) and derive the flow rate of drinking water through the manifold, then drive the motor and pump. Alternatively, since chamber 36 has a fixed column of water above it before it vents to atmospheric pressure, the head pressure at this location is essentially a constant amount above atmospheric pressure, and can be subtracted out (offset or biased) without an actual pressure sensor at location 33 or an adjoining port 33, allowing a significant simplification requiring only one pressure sensor at location 32 measuring pressure relative to atmospheric to suffice to measure the drinking water flow rate. The electronic or microcontroller based control so attached may then control the speed of a conventional motor attached to a positive displacement pump to pump the concentrated liquid drinking water enhancer from a remote reservoir or supply bottle through a rigid or flexible supply tube, a portion of which is shown as 27, and into port 34 that merges with the drinking water flow stream in or near the orifice chamber 37, or any other location allowing merging and mixing of the drinking water and concentrated water enhancement liquid streams. By implementing this type of relative pressure sensor based water flow measurement with electronic or microcontroller based positive displacement pump control, the positive displacement pump may be indirectly coupled to the drinking water flow rate (not connected physically by a shaft), and therefore the user may have an adjustment control input device like a potentiometer or digital quadrature encoder dial to adjust the concentrate flow rate as a function of drinking water flow rate, thereby implementing a variable proportional rate control that allows a stronger or weaker water enhancement concentration per volume unit of drinking water. Using this method, the water enhancement liquid delivery rate may be adjusted or turned off completely by the end user if desired. FIG. 15 illustrates a block diagram of this type of electronic control approach for this automatic water enhancement apparatus.

For each of the above alternate embodiments and all ramification variations, the manifold block (1, 28 or 39) may be redesigned to be integral with a water filter faucet base and valve assembly in order to improve the aesthetics of the apparatus, or it may be plumbed-in and fully independent and only connected by plumbing means but remotely located out of sight. In all cases the scope and functionality of this invention remains. FIG. 17 illustrates a schematic installation of manifold 28 with inline plumbing to a typical RO filtered water supply stream 21 and output stream 22 and concentrate supply 27 from a large concentrated water enhancement liquid reservoir 41.

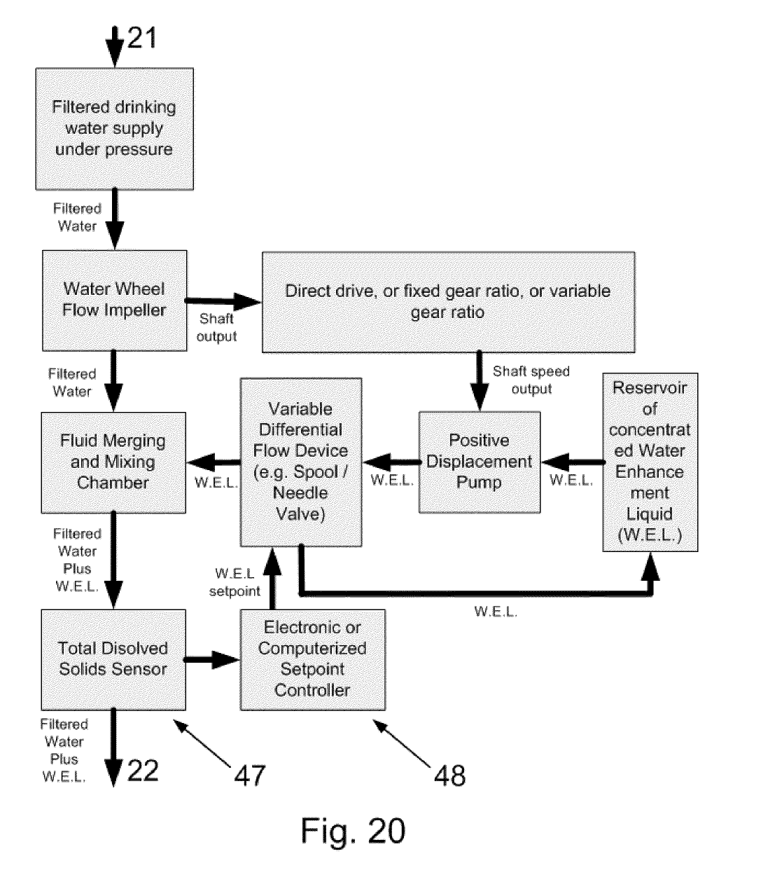

For each of the above alternate embodiments and all ramification variations, an additional servo loop option may be added to improve the control and/or regulation of the water enhancement concentration of the output enhanced drinking water stream 22. By using a Total Dissolved Solids (TDS) sensor 47 to measure the actual TDS being output after the fluid merging and mixing chamber and just prior to being output from this invention apparatus. A TDS sensor is a commonly available component used for water treatment and chemistry and science applications. Typical TDS sensors use the conductivity of the water as a measure of the TDS, and this measurement may be output in a variety of signal types including analog voltage, or various digital electronic formats. Using this actual measurement of TDS, if may be compared to a desired TDS set point, that may be fixed or variable, and may be user selectable by a variety of means suitable for interfacing to an electronic or computerized Set point Controller 48, as shown in FIG. 20. By taking a difference between the desired TDS setting, and the actual TDS output sensed, a TDS error may be determined that may be used to modulate the Water Enhancement Liquid (W.E.L.) set point driving the Variable Differential Flow Device, and thereby increasing or decreasing the concentration of the water enhancement liquid concentration in the output stream 22.

Because it operates automatically, in the simplest embodiment the use requirements for this apparatus are the same as using a filtered water delivery faucet. Specifically, just turning on the faucet to allow filtered water to flow will cause this apparatus to operate and automatically infuse the filtered drinking water with the water enhancement liquid, and deliver it as an output stream to the user like a water faucet normally does. In additional, occasional maintenance is necessary to check the water enhancement fluid level in the reservoir.

In some of the alternative embodiments, a user controlled water enhancement liquid concentration set point control approach is used, and in such case the user will have the additional use requirement to adjust the control input device to specify the desired water enhancement liquid concentration setpoint.

### CONCLUSION, RAMIFICATIONS, SCOPE

In conclusion, this disclosure has described this invention for an automatic drinking water enhancement apparatus consisting of a storage reservoir for water enhancement liquid connected to a positive displacement pump that will pump said water enhancement liquid proportional to the drinking water supply flow rate, and a merging and mixing means to combine the two streams, then to dispense it to the user.

In addition to the preferred embodiments described, included ramifications of this automatic water enhancement apparatus invention are alternative variations in existing available component types and designs including but not limited to the following in particular:
a. No drinking water flow rate measurement device; since RO filters typically require water pressures of at least 45 p.s.i. to operate, and city or well water supply sources typically have a maximum limit of around 60 p.s.i. it is possible to assume an RO filtered water pressure and therefore flow rate, and to deliver the concentrated water enhancement liquid at a fixed rate using a motorized positive displacement pump, with an error of less than about +/−15%, thus saving complexity and cost for entry level water enhancement solutions.
b. Alternative drinking water flow rate measurement device variations including radial, axial, or helical water wheel impeller types, differential pressure sensor type, Doppler based velocimeter type (radar, lidar, or ultrasonic means), interferometer based velocimeter type, differential heat sensor type, venturi type.
c. Alternative positive displacement pump type variations including spur gear pumps, peristaltic pumps, screw pumps, diaphragm pumps, straight or helical twisted roots (e.g. Wendelkolben) pumps, scroll pumps, piston pumps, shuttle block pumps, eccentric swash plate driven piston array pumps, flexible impeller pumps, rotary vane pumps, eccentric rotary pumps (wankle like), and cyclotrochoidal pumps.
d. Single reservoir and single pump or multiple reservoirs and multiple pump configuration variations, with independent or coupled metering and delivery control of each reservoirs fluid concentrate.
d. Water enhancement fluid reservoirs that are refillable or water enhancement liquid reservoirs that are replaceable.
e. Elimination of the water enhancement liquid merging and mixing inside the apparatus, and delivery of a parallel stream of water enhancement liquid, exiting adjacent and pin parallel with the filtered water stream, thereby making the incorporation of said water enhancement fluid visible to the end user.
f. Alternative fluid merging and mixing variations including mixing chambers, flow turbulence inducers, successive stream dividers and remixers, ultrasonic transducer mixers, shakers, stirrers.
g. Automatic water enhancement apparatus location on or near the faucet and output delivery tube, or remotely located.
h. Drinking water with enhancement fluid mixing rate variations including linearly proportional, non linear proportional, user adjustable transfer function profiles, or adjustable and individual enhancement fluid components independently programmable types.
i. Drinking water with enhancement fluid concentration measurement using electronic total dissolved solids measurement techniques as a feedback, and motor speed control implementing pump speed and enhancement fluid rate control as the determinant controlled parameter.

This invention has been described in considerable detail to provide those skilled in the art with the necessary and relevant information to apply the novel principles and to construct and use such specialized components as required. However, it is understood that the invention can be carried out by different equipment, materials, and devices, and that various modifications, both to the equipment and operating procedures, can be accomplished without departing from the scope of this invention itself.

1. An automatic drinking water enhancement apparatus, comprising:
a. a supply reservoir manifold, or a tube connected to a supply reservoir vessel, providing a source of drinking water enhancement liquid to a liquid pumps inlet, and
b. a liquid pump, configured to automatically pump said concentrated water enhancement liquid into, or in parallel with, a drinking water stream when the drinking water stream is flowing, and proportional to the filtered water flow rate.

2. The object of claim 1 where the water enhancement liquid pump is powered by the drinking water stream by means of a drinking water pressure and flow driven impeller.

3. The object of claim 1 where the water enhancement liquid pump is powered by an electric powered motor.

4. The object of claim 1 or 2 or 3 with a drinking water supply flow rate measurement means allowing the addition of a precisely metered amount of water enhancement liquid proportional to the drinking water stream flow rate.

5. The object of claim 1 or 2 or 3 or 4 with a drinking water and liquid water enhancer mixing means.

6. The object of claim 1 or 2 or 3 or 4 or 5 with a quick connect means to attach one or more water enhancement liquid reservoirs, embodied as an open or closed manifold and containing water enhancement liquid on the interior of said manifold such that it may be delivered to the pump when installed.

7. The object of claim 1 or 2 or 3 or 4 or 5 or 6 with a user controlled set point to adjust the concentration desired of water enhancement liquid in the apparatus output stream 22.

8. The object of claim 3 or 4 or 5 or 6 or 7 with an electrical or electronic Total Dissolved Solids (TDS) sensor measures the total dissolved solids of the output enhanced drinking water stream, where that TDS sensor measurement is used in a servo control feedback loop to adjust the actual water enhancement liquid concentration in the output stream, such that a known preset or user specified set point for the water enhancement liquid concentration is delivered at the output enhanced drinking water stream 22.
